(19) United States
(12) Patent Application Publication
(10) Pub. No.: US 2026/0127985 A1
(43) Pub. Date: May 7, 2026

(54) INSERT HOLDER SYSTEM AND RELATED METHODS FOR COLLECTIBLE ITEMS

(71) Applicant: Collectors Universe, Inc., Santa Ana, CA (US)

(72) Inventors: Geoffrey Wolfe, Irvine, CA (US); Travis Tapay, Irvine, CA (US); Mark Frisbee, Ladera Ranch, CA (US); Ben Bailey, Apopka, FL (US); Brian Alvey, Mission Viejo, CA (US)

(73) Assignee: Collectors Universe, Inc., Santa Ana, CA (US)

(21) Appl. No.: 19/377,163

(22) Filed: Nov. 3, 2025

Related U.S. Application Data
(60) Provisional application No. 63/716,027, filed on Nov. 4, 2024.

(51) Int. Cl. G09F 1/10; G06T 1/00

(52) U.S. Cl. CPC G09F 1/10; G06T 1/0007

(57) ABSTRACT

A method for protecting a collectible item, a combination cardcase and collectible item, and an insert for positioning the collectible item. The method includes capturing image data of the collectible item. The method further includes generating an insert template of the collectible item based on the captured image data.

### CROSS-REFERENCE TO RELATED APPLICATION

This is a regular utility application of U.S. Provisional Application No. 63/716,027, filed Nov. 4, 2024, the contents of which are expressly incorporated herein by reference.

### FIELD OF ART

The present disclosure is generally directed to safeguarding collectible items, such as baseball cards, game cards, tickets, and coins, with specific discussions on a system for protecting the collectible items within item holders and related methods thereof.

### BACKGROUND

Collectible items such as sport cards, trading cards, game cards, stamps, tickets, and coins, are examples of collectible items collected by hobbyists for both tangible and intangible values. While intangible values may not be as readily measurable, tangible values can be measurable, such as values based on a rarity of a particular trading card and the condition of the card.

Third-party services are available for grading collectible cards for authenticity and condition. Typically, when a card is sent to a grade service provider to be graded, the third party service provider inspects the card, ranks the card for condition, typically on a number scale, seals the card in a tamper-evident holder, and assigns a serial number to the card along with information about the card for future reference. Once a card has been graded by a reputable third-party grader, the authenticity and condition of the card are backed by the reputation of the third-party grader, thus removing any subjectivity of self-assessment. Consequently, the value of the card is typically increased thereby.

Uniquely shaped collectible items, such as die cut cards with multiple curves on the outer contours of the cards, can be difficult to properly secure within a given card holder. Since a die cut card may not have squared corners or straight edges that match the card holder, the die cut card may undesirably move within the holder. It is known to overlay the die cut card with front and back mylar layers within the card holder. Though the mylar layers help prevent the die cut card from moving, the film or gloss of the mylar layers diminishes the aesthetic appeal of the card holder. Additionally, the die cut card may nevertheless drift from its original position, which further diminishes the aesthetic appeal of the card holder.

### SUMMARY

Broadly speaking, aspects of the invention are directed to systems and methods for protecting uniquely shaped collectible items within custom designed inserts that are positionable within item holders. Each insert includes an item opening that is specifically tailored to receive a given collectible item therein. The insert retains a desired position of the collectible item relative to the item holder.

Aspects of the invention include a method for protecting a collectible item. The method includes capturing image data of a collectible item. The method further includes generating an insert template of the collectible item based on the captured image data.

In one embodiment, the step of capturing image data comprises capturing a silhouette image of the collectible item.

In one embodiment, the insert template is configured to be used by a laser cutter to create a custom insert within which the collectible item is positionable.

In one embodiment, the collectible item comprises a die cut card.

In one embodiment, the method further comprises generating an initial silhouette template based on the captured image data of the collectible item.

In one embodiment, the step of generating the insert template comprises generating a bounding box, positioning the initial silhouette template within the bounding box, and resizing the bounding box, along with the initial silhouette template therein, to match a size of the collectible item. The step of generating the insert template further comprises tracing a path around the initial silhouette template and increasing a size of the traced path by approximately 0.005 inches to create the insert template.

In one embodiment, the step of positioning the initial silhouette template within the bounding box comprises generating and positioning a reference line on the initial silhouette template corresponding to a periphery line of the collectible item and rotating the initial silhouette template to align the reference line thereof to a corresponding boundary line of the bounding box.

Aspects of the invention further include a method for protecting a collectible item within an item holder. The method comprises capturing image data of a collectible item, generating an insert template of the collectible item based on the captured image data, and forming a custom insert based on the generated insert template. The custom insert is configured to receive and position the collectible item within an item holder.

In one embodiment, the custom insert comprises an item opening with a contour that corresponds to a size and a shape of the collectible item.

In one embodiment, the custom insert comprises an outer contour that is complimentary to an inner periphery of the item holder.

In one embodiment, the outer contour of the custom insert comprises four locating features configured to align and secure the custom insert within the item holder.

In one embodiment, the custom insert is a gasket which bounds the collectible item.

In one embodiment, the custom insert comprises a polyethylene terephthalate (PET) sheet.

In one embodiment, the step of forming the custom insert comprises laser cutting the custom insert by a laser cutter.

In one embodiment, the laser cutter is configured to cut an outer periphery of the custom insert that is complimentary to an inner periphery of the item holder and an item opening that has a contour that is complimentary to an outer contour of the collectible item.

In one embodiment, the method further includes laser cutting, by the laser cutter, rounded inner apexes in the custom insert corresponding to inner apexes of the collectible item. The method further includes laser cutting, by the laser cutter, sharp outer apexes in the custom insert corresponding to outer apexes of the collectible item, preventing the custom insert from damaging the collectible item when seated therein.

Aspects of the invention further include a method of producing card holders. The method includes producing a first enclosed card holder. The first enclosed card holder includes a first label, a first collectible item with a first outer contour, and a first insert with a first item opening that receives the first collectible item therein. The first item opening comprises a first interior contour complimentary to the first outer contour of the first collectible item. The method further includes producing a second enclosed card holder. The second enclosed card holder includes a second label, a second collectible item with a second outer contour differing from the first outer contour of the first collectible item, and a second insert with a second item opening that receives the second collectible item therein. The second item opening comprises a second interior contour complimentary to the second outer contour of the second collectible item.

In one embodiment, the method further includes laser cutting, by a laser cutter, the first interior contour of the first item opening of the first insert based on image data of the first collectible item. The method further includes laser cutting, by the laser cutter, the second interior contour of the second item opening of the second insert based on image data of the second collectible item.

In one embodiment, the method further includes laser cutting, by a laser cutter, a first outer contour of the first insert complimentary to a first inner periphery of the first enclosed card holder such that the first insert is securely seated within the first enclosed card holder. The method further includes laser cutting, by the laser cutter, a second outer contour of the second insert complimentary to a second inner periphery of the second enclosed card holder such that the second insert is securely seated within the second enclosed card holder.

In one embodiment, the first and second enclosed card holders are produced within three hours of one another.

Aspects of the invention further include a system including an imaging device comprising an optical sensor, a platform, and a light positioned underneath the platform. The optical sensor is configured to capture image data of a collectible item. The image data includes a silhouette image of the collectible item. The system further includes at least one hardware processor in communication with the imaging device and configured to generate an insert template based on the image data. The system further includes an insert production device in communication with the at least one hardware processor and configured to generate an insert based on the insert template. The insert is configured to receive and position the collectible item within an item holder.

In one embodiment, the insert comprises integrated locking features configured to engage with an inner periphery of the item holder to immobilize the insert when the insert is positioned within the item holder.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a schematic view of a collectible item insert holder system for forming custom inserts to match uniquely shaped collectible items, positioning the items within the custom inserts, and sealing the subassembly of the inserts and collectible items within respective item holders by welding the item holders together.

FIG. 2 illustrates a top view of an enclosed item holder with a label, a custom insert, and a collectible item seated within the insert.

FIGS. 3A-3B illustrate the two-part item holder for encasing a collectible item. FIG. 3A is a plan view of an inside of a first, male part of the item holder. FIG. 3B is a plan view of an inside of a second, female part of the item holder.

FIG. 4 illustrates a front view of an insert that has an outer boundary which corresponds to an inner periphery of the card holder and an item opening with an interior contour which corresponds to an outer periphery of the collectible item.

FIG. 5 is a flowchart of a method for forming a custom insert to retain a corresponding collectible item with an item holder.

FIG. 6 is a flowchart of a method for laser cutting a custom insert.

FIG. 7 is a flowchart of a method for generating an insert template of the collectible item.

FIG. 8 illustrates a silhouette image of a collectible item.

FIG. 9 illustrates an initial silhouette template of the collectible item, with a reference line positioned thereon.

FIG. 10 illustrates a boundary box with the initial silhouette template therein.

FIGS. 11A-11B illustrate a traced path of the initial silhouette template and an insert template, respectively.

FIG. 12 illustrates a top view of another embodiment of an enclosed item holder with a label, a custom insert, and a collectible item seated within the insert.

FIG. 13 illustrates a detail view of a corner of the custom insert with the collectible item therein.

### DETAILED DESCRIPTION

The detailed description set forth below in connection with the appended drawings is intended as a description of the presently preferred embodiments of enclosed item holders, in accordance with aspects of the present devices, systems, and methods, and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

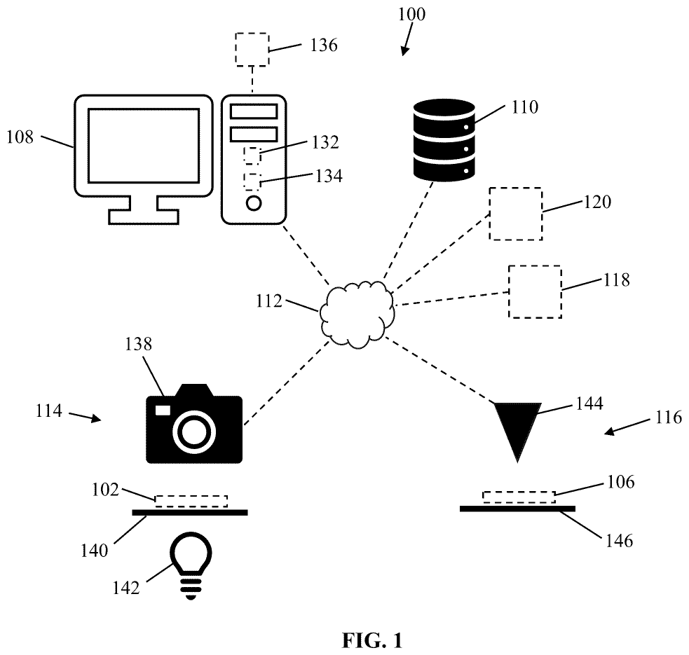

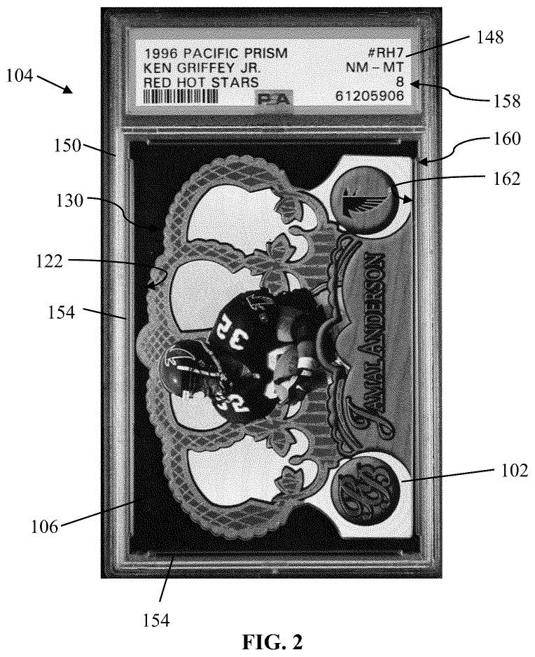

FIGS. 1-4 illustrate an embodiment of a insert holder system 100 for securing collectible items 102, such as cards, including die cut cards, tickets, coins, or any other desired items, within respective item holders 104. For purposes of the present disclosure, collectible items will be discussed in the context of collectible cards although other collectible items can practice the invention as described. The insert holder system 100 is equipped with software and hardware to perform one or more of imaging the collectible items 102, analyzing and cataloging the collectible items 102, and securing and welding the collectible items 102 within item holders 104 (FIG. 2). In particular, for each of the collectible items to be processed, the system 100 is configured to generate a custom insert 106 based upon captured image data of the actual collectible item 102 that is received for processing. The custom insert 106 is then assembled with the uniquely shaped collectible item 102 in an item holder 104, wherein a desired position and orientation of the collectible item 102 within the enclosed item holder 104 is set and maintained by the insert 106.

In one embodiment, as shown in FIG. 1, the insert holder system 100 may include one or more controllers 108, a remote database 110, a communications network 112 operably connecting the components of the system 100, and various workstations particularly configured to perform different tasks. The workstations may include an imaging station 114, an insert or gasket production station 116, a welding station 118, an inspection and cataloging station (not shown), wherein the collectible item 102 is analyzed, assigned a value or score, or any other desired workstations. In one embodiment, the insert holder system 100 may also include one or more inspection stations 120 that may inspect the collectible items 102, the inserts 106, the item holders 104, a position of the collectible item 102 and/or insert 106 within a given item holder 104, and/or a weld or securement point(s) of the item holders 104 to evaluate whether or not the item holders 104 are properly sealed. The system 100 may be practiced with fewer or less than all the workstations mentioned. For example, the system 100 may comprise workstations for imaging collectible items, creating custom inserts, and assembling the inserts and the collectible items in item holders only.

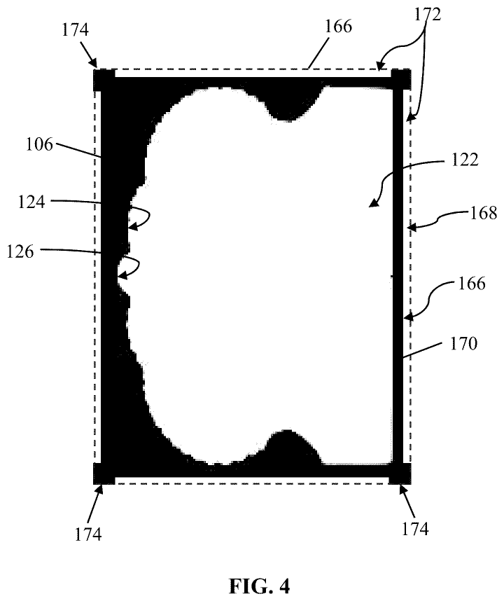

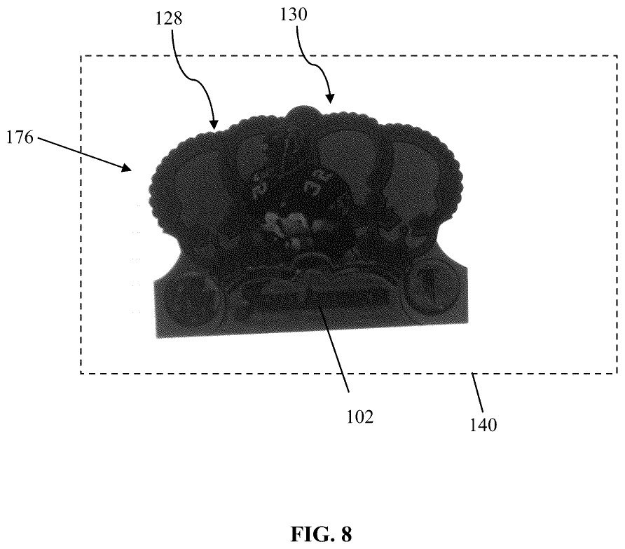

The insert holder system 100 can intake and analyze collectible items 102, and thereafter create specifically tailored (i.e., custom) inserts or gaskets 106 that are form fitting with the uniquely shaped collectible items. For each item holder, a combination custom insert and collectible item is rigidly secured therein, typically with a label for identifying the collectible item and for indicating other information, such as a grade or a score. Broadly speaking, the system 100 is configured to capture image data of each collectible item 102 to be processed at the imaging station 114 and laser cut an insert 106 specifically tailored for the given collectible item 102 via the insert production station 116, based on the captured image data of the collectible item, as discussed further below. Thereby, as shown most clearly in FIG. 4, the insert 106 may include an item opening 122 with a contour or surface profile 124 defined by its perimeter wall 126 (inside edge) that is complimentary (in shape and size) to an outer contour 128 defined by a perimeter wall 130 of the body of the collectible item 102 (see also FIG. 8), e.g. an outer periphery or outline of the collectible item 102 or a portion thereof. Thus, when a collectible item 102 is seated within a custom insert 106, the collectible item 102 is substantially rigidly secured or fixed in place by the insert 106, wherein the periphery of each collectible item 102 is surrounded by the periphery of the item opening 122 of the insert 106, thus preventing the collectible item 102 from moving or shifting within the item holder 104 (or at least substantially limiting the movement thereof). Additionally, the insert 106 may engage and cooperate with the perimeter wall 130 of the collectible item only, and thus the insert 106 may not cover or obstruct the front or back side of the collectible item, allowing the collectible item 102 to be easily visible and properly showcased within the item holder 104. Reflective effects of prior art mylars are therefore eliminated through use of the custom inserts in accordance with aspects of the invention.

The one or more controllers 108 can control the various operations of the workstations 114, 116, 118, 120. Only a single controller 108 will be discussed herein going forward, although more than one controller, which can be a local controller or a cloud based system having remotely located controllers, may be used. The controller 108 may comprise at least one hardware processor 132 and at least one memory 134. The at least one hardware processor 132 may include or be in communication with an image processing module 136, as shown in phantom in FIG. 1, that can be configured to process image data captured by the imaging station 114. For example, the image processing module 136 may identify the outer contour 128 (or periphery) of the perimeter wall 130 (or edge) of a given collectible item 102, determine the dimensions (e.g., a height, width, depth) of the collectible item 102, identify any inner and/or outer apexes, and/or any other unique features or characteristics of the collectible item 102, as discussed further herein.

The controller 108 can be connected to various field devices, including robotic mechanisms of the workstations, such as valve banks for controlling pneumatic grippers, a weld controller of a welder of the welding station 118, servo motors, an input/output (I/O) device, such as a human machine interface (HMI), a printer, or other display screen. In some embodiments, each workstation may comprise a separate controller for controlling the operations thereof. The controller 108 may comprise any suitable computing device or combination of devices, such as a desktop computer, a laptop computer, a smartphone, a tablet computer, a wearable computer, a server, a virtual machine being executed by a physical computing device, etc. Each memory 134 can have stored thereon instructions that when executed by the at least one hardware processor 132 cause the at least one hardware processor 132 to perform several tasks, including access data files, analyze data files, perform analysis of the data files, and provide outputs indicative of characteristics or parameters represented by the data files. The insert holder system 100 can be a practical application of a device, system, and method in the field of collectible items, and specifically for imaging and housing collectible items 102 (for protection and cataloging thereof), which may collectively enhance the value and security of the collectible items 102.

In some embodiments, the one or more controllers 108 can execute an artificial intelligence (AI) model to inspect and automatically detect various characteristics, parameters, measurements, and other aspects of the collectible items 102, the inserts 106, and/or the item holders 104. In one embodiment, the controller 108 may include a neural network in its processor 132 to determine a type of item holder 104, a type of collectible item 102, a specific contour (or outline of the periphery) of the collectible item 102, a template or pattern or set of instructions to form a given insert 106, and whether the insert 106, the position of the collectible item(s) therein, and/or the position of the insert 106 within the item holder 104 is within acceptable tolerances.

Exemplary machine learning, such as AI models, include convolutional neural networks (CNNs). Preferred CNN models include the VGG16 Net and VGG19 Net models, which can be re-trained to analyze and classify a type of collectible item 102, a shape and size of a collectible item 102, including a contour or outer periphery 128 thereof, a height, a width, and a depth thereof, a template of an insert 106 based on the corresponding collectible item 102, a position of the collectible item 102 within the insert 106, a position of the insert 106 within the item holder 104, and acceptable tolerances from the desired centered position based on a data set of known item holders 104, collectible items 102, desired angles or offsets related to apexes or curves which may or may not be keyed to a particular item holder 104, a desired position of the insert 106 and/or collectible item 102 within the item holder, and/or various pre-determined acceptable tolerances. The CNNs can be previously trained as a general image classifier and/or image profiler to determine the profile, size, and shape of the image collectible item 102, insert 106 and/or item holder 104. Other deep neural networks for image processing are contemplated, such as LeNet, AlexNet, GoogLeNet/Inception, and ResNet, ZFNet. In other examples, the system receives query images in the form of one or more images and sends the one or more images to an identification model (a trained model) to generate query embedding vectors. The query embedding vectors are compared to the identification embedding vectors of previously saved data files to find similar vectors.

The database 110 may be a remote database of a separate database server. The database 110 can be configured to store the image data captured by imaging workstation. The database 110 may also store relevant information regarding the collectible items 102, such as the characteristics, condition, and pricing information thereof. The database 110 may also store information regarding past or present inserts 106 which were generated by the insert forming station.

The communication network 112 can be any suitable communication network or combination of communication networks. For example, the communication network 112 can include a Wi-Fi network (which can include one or more wireless routers, one or more switches, etc.), a peer-to-peer network (e.g., a Bluetooth network), a cellular network (e.g., a 4G network, a 4G network etc., complying with any suitable standard, such as CDMA, GSM, LTE, LTE Advanced, WiMAX, etc.), a wired network, such as an ethernet cable, etc. In some embodiments, the communication network 112 can be a local area network, a wide area network, a public network (e.g., the Internet), a private or semi-private network (e.g., a corporate intranet), any other suitable type of network, or any suitable combination of networks. Communications links can be any suitable communications link or combination of communications links, such as wired links, fiber optic links, Wi-Fi links, Bluetooth links, cellular links, etc. The communication network 112 can include any suitable hardware, firmware, and/or software for establishing communication between the one or more controllers 108 and/or any other desired network. For example, the communication network 112 can include communications systems that comprise one or more transceivers, one or more communication chips and/or chip sets, etc. In a more particular example, communications systems can include hardware, firmware and/or software that can be used to establish a Wi-Fi connection, a Bluetooth connection, a cellular connection, an Ethernet connection, etc.

The imaging station 114 can be configured to capture image data of the collectible items 102. The imaging station 114 can comprise an optical sensor 138, e.g., a camera with a lens, for capturing image data, e.g., photos or videos, of the collectible items 102. In an exemplary embodiment, as shown in FIG. 1, the imaging station 114 may also include a platform or nest 140, e.g. a glass platform, underneath the optical sensor 138 and which is backlight by a light 142 positioned underneath the platform 140, which thereby allows the optical sensor 138 to capture silhouette images of the collectible items 102 on the platform 140, as discussed further herein with respect to FIG. 8. The images of the silhouette can then be processed to generate the contour of the item opening 122 of a corresponding insert 106 for use with the collectible item.

The insert production station 116 can be configured to generate one or more custom inserts 106 based on the captured image data of the collectible item(s) 102 from the imaging station 114. In an exemplary embodiment, as shown in FIG. 1, the insert production station 116 can comprise an insert production device 144 in the form of a laser cutter and a platform 146 upon which the insert 106 is laid upon. Each data file can be created from one or more silhouettes of a collectible item. The data file can contain an outline of the item opening 122 for use by the production device to laser cut, and optionally of an outer perimeter of the insert to also be laser cut. The controller 108 then uses the data file to control one or more servo motors to move the laser cutter 144 and/or the platform as desired to laser cut a blank insert material to form the custom insert 106 in accordance with aspects of the invention. In another embodiment, the insert production station 116 may additionally or alternatively comprise an additive manufacturing device, such as a 3D printer, for producing the insert 106 (or portions thereof). An exemplary laser cutter is a Universal Laser model VLS 6.60.

The welding station 118, as shown in phantom in FIG. 1, can be configured to weld or otherwise seal the item holders 104 after the inserts 106 and collectible items 102 are placed therein, as separate insert/collectible item combination. The welding station 118 may comprise a welder, a welding platform or nest, one or more optical sensors, and one or more servo motors for manipulating the welder and/or platform.

Referring to FIG. 2-4, there is shown an exemplary item holder 104 (FIG. 2) comprised of a multipart holder or case, a label 148, and an insert or gasket 106 (FIG. 4) that receives and retains one or more collectible items 102 within the item holder 104 at a desired location and orientation. In an example, as shown in FIG. 2, the insert 106 is matched with one collectible item 102, in a one to one relationship, and the combination is located inside the item holder 104. In an example, the collectible item 102 is a die cut card having a unique outer card contour and the insert 106 has an item opening 122 with a corresponding negative contour for mating with the contour of the collectible item. In some embodiments, the insert holder system 100 may generate one insert 106 that receives and retains multiple collectible items 102 therein inside of the item holder 104 to retain the multiple collectible items from shifting, and to optionally align and center the collectible items in the desired position within the item holder. In some embodiments, the insert holder system 100 may generate multiple inserts 106 (or portions thereof that form a collective insert 106) that receive and retain one or more collectible items 102 therein.

The label 148 can be provided with information regarding the collectible item held inside the item holder along with the label, which can include an identification number, a barcode and/or QR code that can be used to access a database 110 to verify the identification or certification number, the name of the grading entity, and a final grade “#”, among other information. In some embodiments, the label 148 can be a QR code printed on stock paper that is placed inside the item holder 104 by the operator. In some embodiments, a near field communication (NFC) chip may be included in the item holder 104. An App running on a smartphone may be used to access information stored in the NFC chip, which can include a security handshake and a link to a webpage that provides additional information about the collectible item 102. The label 148 can be in the form of an insert that is fitted within the item holder 104.

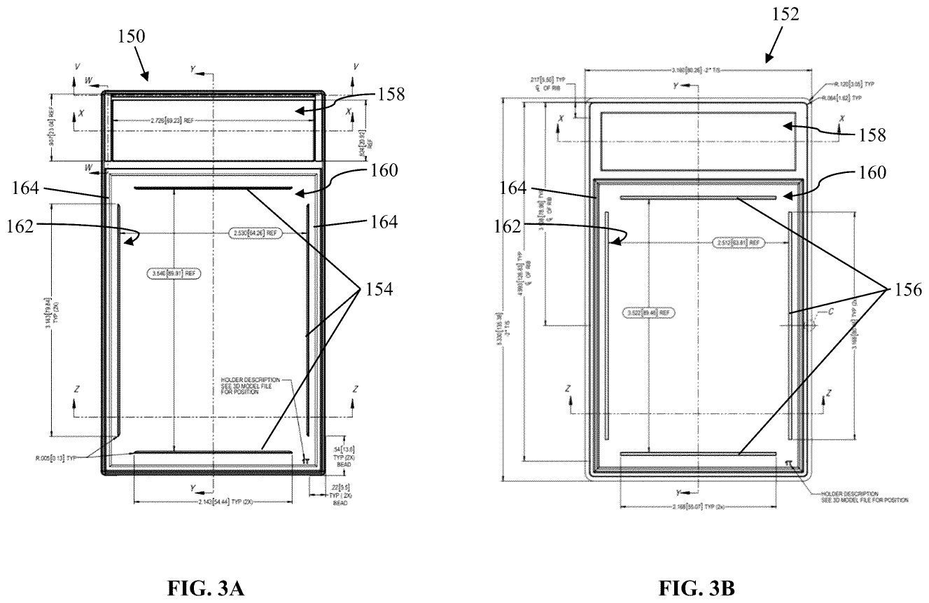

Referring to FIGS. 3A-3B, each item holder 104 can comprise a multipart clear plastic housing 104, including a top male part 150 (FIG. 3A), which can be referred to as a first housing part, and a bottom female part 152 (FIG. 3B), which can be referred to as a second housing part, that lock together to provide a temporarily secured housing. Exemplary holders are disclosed in U.S. Pat. No. 11,807,435, the contents of which are expressly incorporated herein by reference. Once temporarily locked, the item holder can pass along to a welding station to weld the perimeter of the item holder to more permanently secure the collectible item therein.

A holder securement feature comprising a male part and a female part, such as cooperating detents, recesses, protrusions, grooves, etc., can be used to secure the two-piece holder 104 together. The securement feature can provide an irreversible lock that cannot separate once engaged. For example, the male part 150 can include four outwardly protruding ribs 154 that fit within four corresponding grooves 156 in the female part 152. The male part 150 can additionally include protrusions at one or more locations around its perimeter that clamp onto or extend into corresponding portions or recesses of the female part 152. After connecting the male and female parts 150, 152 together, the two piece holder 104 may be welded together via the welding station 118 to provide an even more secured item holder 104. The item holders 104 may be identical to one another or may differ from one another in size and shape.

Each item holder 104 can define an internal label section 158 to retain an identifier or label 148 therein and an item section 160 to retain the insert 106 and the collectible item 102 therein. The item section 160 defines an insert compartment within which the insert 106 is seated, and within which the collectible item is seated. The item section 160 has an interior contour or periphery 162 (FIG. 3A) defined by outer walls and/or ribs provided with the housing sections. In one embodiment, the periphery 162 of the item section 160 can be defined by the side walls 164 and ribs 154 of the male part 150 and/or the side walls 164 and grooves 156 of the female part 152, wherein the periphery 162 comprises a substantially rectangular cross-section with polygonal, e.g., square, inner corners.

Referring now to FIG. 4, there is shown an exemplary embodiment of an insert 106 that is positionable within the item section 160 of the item holder 104. The insert 106 is considered a custom insert in that the contour of the item opening 122, formed by laser cutting the insert stock material to create the contour or surface profile 124 of the item opening, is shaped-dependent on the outer peripheral contour of a collectible item for which the insert is fabricated to use with. An uncut insert or sheet 166 is shown in phantom lines surrounding the cut and/or printed insert 106. The insert 106 can have a custom outer contour 168 defined by an outer perimeter wall 170 (e.g., the top, bottom, left, and right side walls 170) that is complimentary (in shape and size) to the inner periphery 162 of the item section 160 of the item holder 104. As discussed above, the insert 106 can also have a custom item compartment or opening 122 within which one or more collectible items 102 are seated. Prior to cutting the perimeter wall 126 to form the item opening, the item opening 122 can be enclosed or filled by the body of the insert 106, forming an interior contour 124. The material of the insert 106 can be a polyethylene terephthalate (PET) sheet, as shown in phantom in FIG. 4. Therein, the insert 106 may comprise a clear or see-through body. For illustrative purposes, the insert 106 is shown as an opaque member. In other examples, the material of the insert 106 can be colored, opaque, semi-opaque, or made from a different material, such as from plastic coated paper.

In one embodiment, the laser cutter 144 may remove portions of the outer perimeter wall 170 of the uncut sheet 166 to match the inner periphery 162 of the item holder 104, and to do so with a desired tolerance or clearance, such as with 5 to 15 thousandths of an inch clearance on each side of the insert. Furthermore, the laser cutter 144 may remove portions of the middle (or inside) of the uncut sheet 166 to form the item opening 122, such as to cut an opening to form a perimeter wall 126 having a contour 124 that matches the outer contour or periphery 128 of the perimeter wall 130 of the collectible item 102. The perimeter wall 126 of the opening 122 can be cut to an opening size that is about 5 -15 thousandths larger than the outer contour of the collectible item.

In an example, the laser cutter 144 may create four rib cutouts or recesses 172 in the insert 106, e.g., in the top, bottom, left, and right sides 170 thereof. The rib cutouts 172 may only extend through a portion of each side wall 170, leaving the shaped corners 174 of the insert 106 intact. The uncut corners 174 may extend beyond the rib cutouts 172 (and sides 170 thereof) of the insert 106. Each corner 174 may comprise a polygonal corner with a polygonal, e.g., triangular, square, diamond-like, hexagonal, etc., cross-section, or an irregular shape that is configured for fitting into corresponding corners of the item section. In some examples, the corners 174 can be omitted and the outer contour of the insert is generally rectangular. Thus, when inserted into the item holder 104, the corners 174 of the insert 106 may extend radially outwardly beyond the ribs 154, securing or otherwise mechanically locking the insert 106 within the item section 160 of the item holder 104. Furthermore, when inserted into the item holder 104, the rib cutouts 172 of the insert 106 can mate with the ribs 154. In other words, the ribs 154 can be respectively seated into the rib cutouts 172 of the insert 106, further securing the insert 106 within the item holder 104. Hence, the corners 174 of each insert 106 may define and function as locking features 174 that abut against the inner perimeter 162 of the item holder 104 and/or the ribs 154 thereof, preventing or limiting the insert 106 from moving when transporting the item holder 104 (see also FIG. 2).

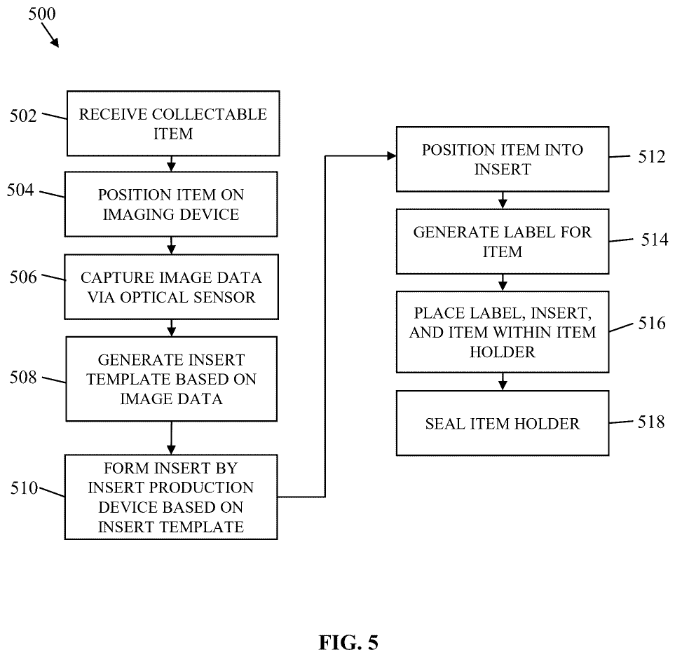

Referring now to FIG. 5 in addition to FIG. 1, there is shown an exemplary method or process 500 of operating the insert holder system 100 to produce a sealed item holder 104 with a custom insert 106 that houses one or more collectible items 102. The process starts at step 502, where a collectible item 102 is received for processing, such as to encase in a holder, to cataloged, to identified with a unique number, and/or to grade. The collectible item is then moved to the by the insert holder system 100. At step 504, the collectible item 102 is positioned on the platform 140 of the imaging station 114. At step 506, the optical sensor 138 captures image data of the collectible item 102. For example, the optical sensor 138 may take a video or one or more photos of the collectible item 102. The image data can be stored in the database 110.

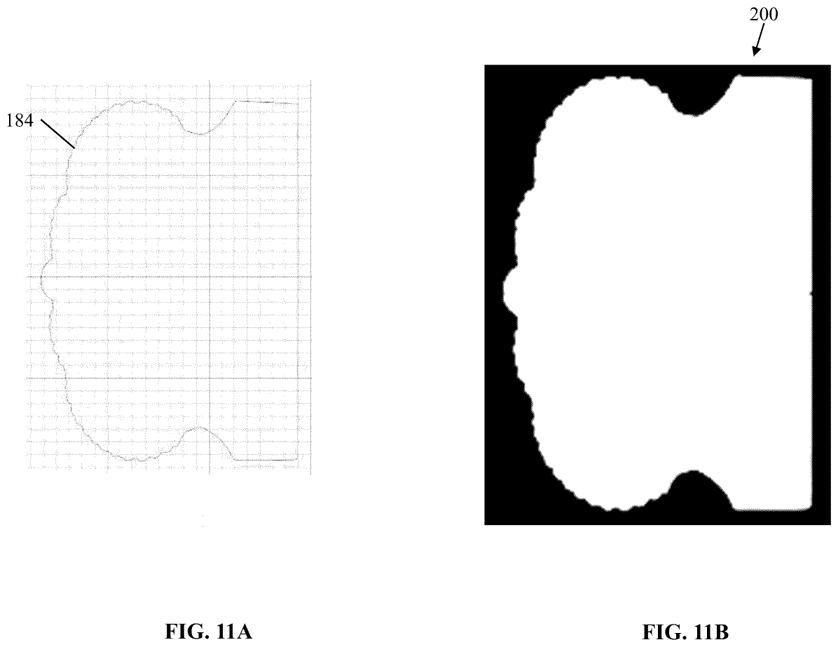

At step 508, the one or more controllers 108, e.g., the image processing module 136, may autonomously or semi-autonomously generate an insert template 200 (see e.g., FIG. 11B) based on the captured image data. For example, in one embodiment, the image processing module 136 may initially identify a particular collectible item 102 or items within a given image, such as the type, kind, or other identifying characteristic thereof. Then, the image processing module 136 may determine a size and shape of each collectible item 102. The image processing module 136 may determine the height, width, and/or depth of the collectible item 102 by comparison to a reference measurement, e.g., a ruler positioned next to the collectible item 102 in the image, identifying and converting a digital measurement, e.g., pixel count of the collectible item 102 within the image, to a real physical measurement, e.g., inches, and/or accessing the known dimensions of the previously identified collectible item 102 in the database 110. Additionally, the image processing device may also determine a size and shape of the item holder, and the item section 160 thereof.

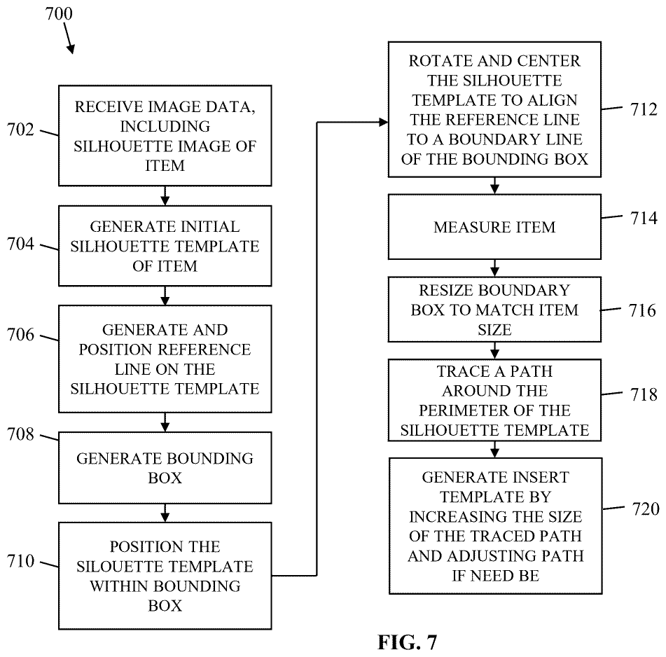

Thereafter, the one or more controllers 108 can generate the insert template 200 that includes a size and shape of the insert 106 and/or instructions on how to create the insert 106 with the determined size and shape, based upon the determined size and shape of a silhouette of a specific collectible item 102. In particular, the outer contour (or perimeter) and/or the item opening 122 (or compartment) of the insert 106 can be determined and generated by the one or more controllers 108. When determining the outer contour of the insert 106, the one or more controllers 108 may select a preset contour based upon a particular item holder 104 and/or calculate an outer contour by previously determining an inner periphery of the item holder 104 (e.g., a size and shape of the item section 160) and downsizing that periphery by a preset amount or percentage to thereafter arrive at the desired outer contour of the insert 106. When determining the item opening 122 contour, the one or more controllers 108 may determine an outer contour of the collectible item 102 and then increase the size of the outer contour by a present amount or percentage. For example, in one embodiment, the size of the outer contour of the collectible item 102 may be increased by approximately 0.005 inches, plus or minus 0.004 inches. In another embodiment, the size of the contour of the collectible item 102 may be increased by approximately 0.01 inches, plus or minus 0.005 inches. Thus, the outer contour of the insert 106 may be complimentary to the size and shape of the inner periphery of the item holder 104 and/or the item opening 122 contour may be complimentary to the size and shape of the collectible item 102. In one embodiment, the one or more controllers 108 may semi-autonomously generate the insert template 200 based upon an initial silhouette or insert template 200, as discussed below with respect to FIG. 7.

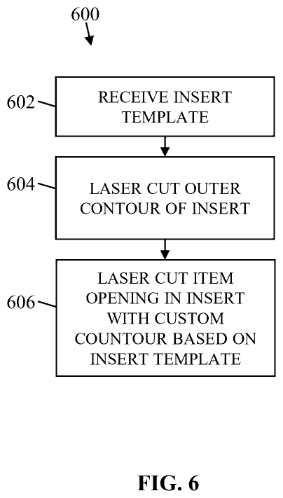

At step 510, the insert production device may create the insert 106 based upon the generated insert template 200. For example, the insert production device may cut the insert along the paths generated on the template 200 and/or 3D print an insert 106 based upon the generated insert template 200. Additionally, for example, the insert production device can be in the form of a laser cutter 144 which forms the insert 106 via cutting away portions of a PET sheet, as discussed further herein with respect to FIG. 6 below.

At step 512, the insert holder system 100 can position the collectible item 102 into the insert 106. In practice, a technician may place the collectible item into the opening of the customer insert, or an automated system may be created to automate the steps described herein, including using a robot arm to place the collectible item into the opening of the custom insert. The collectible item 102 may be seated within the insert 106, wherein the edge(s) of the collectible item 102 faces and/or engages with the edge(s) of the item opening 122 of the insert 106. In one embodiment, the insert 106 is seated flush with the front and back sides of the collectible item 102 (or has a depth that is substantially equal to or less than the depth of the collectible item). Hence, in some embodiments, the insert 106 does not cover the front or back surfaces of the collectible item 102.

At step 514, the one or more controllers 108 may generate and/or print a label 148 with information linked to the collectible item 102. At step 516, the insert holder system 100 may place the label 148, the insert 106, and/or the collectible item 102 within the item holder 104. The label 148, the insert 106, and/or the collectible item 102 may be inserted into the item holder 104 individually or together as a subassembly. In practice, a technician may perform these steps manually, or an automated system can be designed to perform these steps automatically. At step 518, the welding device of the welding station 118 may seal the item holder, thereby enclosing the label 148, the insert 106, and the collectible item 102 therein.

Thereafter, the steps of the method 500 may be repeated to produce subsequent item holders 104 having custom fitted inserts 106 therein for use with corresponding item holders. In one embodiment, subsequent enclosed item holders 104 may be produced relatively quickly. For example, subsequent enclosed item holders 104 may be produced within approximately three hours, plus or minus two hours, or quicker. Thereby, the insert holder system 100 may efficiently and cost-effectively produce enclosed item holders 104 with custom inserts 106 respectively tailored to specific item holders 104. In an example, the insert holder system 100 is configured to produce a first custom insert for a first collectible item having a first outer contour. Thus, the first custom insert is understood to have an item opening having complementary contour or surface profile for receiving the first collectible item. The insert holder system is further configured to produce a second custom insert for a second collectible item having a second outer contour, and a third custom insert for a third collectible item having a third outer contour, and wherein the first and second outer contours are different from one another. In another example, the first and the third outer contours are different from one another. In yet another example, the second and the third outer contours are different from one another. In some examples, the first and the second custom inserts can be fabricated by the insert holder system within 1 hour from one another, preferably within 45 minutes from one another, and more preferably within 20 minutes from one another. Different outer contours are understood to mean curves on the outer perimeter of the different collectible items being different, in either size, shape, the number inflection points, the radii of curvatures, the straight segments incorporated in the outer contours, or combinations thereof.

Referring to FIG. 6, there is shown an exemplary method or process 600 for laser cutting uncut stock sheets to produce custom inserts 106. If the insert production device incorporates a laser cutter 144, then the insert 106 may be produced by the laser cutting method of FIG. 6. At step 602, the insert template 200 can be received by the one or more controllers 108 which operate the laser cutter 144. The uncut sheet can be positioned on the platform of the insert production device. At step 604, the laser cutter 144 may cut the outer contour of the insert 106. For example, in one embodiment, the laser cutter 144 may remove four rib cutouts at the top, bottom, left, and right sides of the body of the insert 106. The corners of the insert 106 may be left uncut, thereby forming an insert 106 with polygonal corners.

At step 606, the laser cutter 144 may cut the item opening 122 in the body of the insert 106, based upon the insert template 200. For example, in one embodiment, laser cutter 144 can remove a middle portion of the insert 106 to thereby create an enclosed item opening 122 with a contour complimentary to the size and shape of the collectible item 102. Thereafter, the now-cut insert 106 can be removed from the platform of the insert production device.

The contour of the item opening to be cut by the laser cutter to produce a custom insert is based on an actual outer contour of a die cut collectible item. The contour on the customer insert to be cut can be based on a silhouette of the actual outer contour. The contour to be cut can be a cutline generated on the insert template 200, which is based on a silhouette of an actual outer contour of a collectible item. The contour to be cut can have an irregular and/or a complex curve. The contour to be cut can be a curve with many inflection points, such as 3 or more inflection points, such as 5 or more, 7 or more, and 9 or more. As shown in FIG. 4, the contour 124 has at least 12 or more inflection points.

Referring to FIGS. 7-13, there is shown an exemplary method or process 700 of generating an insert template 200. The steps carried out by the method 700 can be performed at least in part by the one or more controllers 108. At step 702, the image processing module 136 may receive the captured image data from the imaging device. For example, a collectible item is submitted to a third party grader for authenticating and grading the collectible item. The third party grader then processes the collectible item, such as by placing it on the platform nest to be imaged by the optical sensor. The image data may include a silhouette image 176 of the collectible item, as shown in FIG. 8. The silhouette image 176 of the collectible item 102 may or may not have a correctly oriented and centered position of the collectible item 102. For instance, as shown in FIG. 8, the collectible item 102 is off-center, slightly askew relative to a horizontal plane, and there is no reference measurement from which is determine a relative size of the collectible item 102. The backlit platform 140 of the imaging station 114, shown in phantom, may provide a background or backdrop of the silhouette image 176.

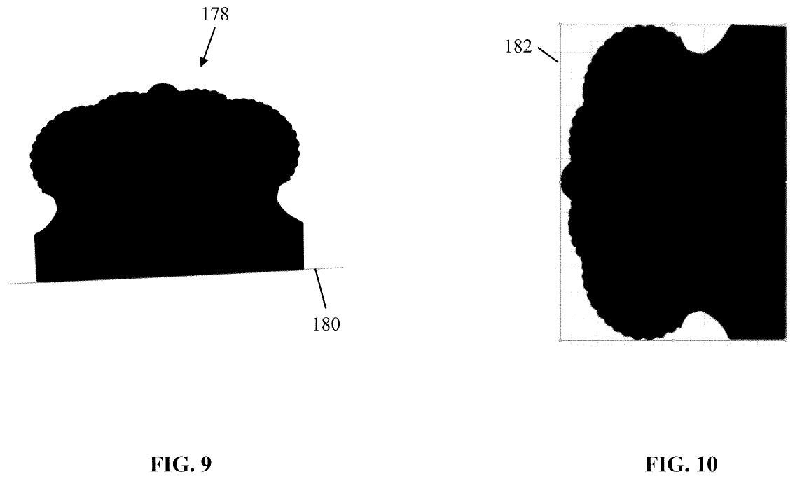

At step 704, an initial silhouette template 178 may be generated. FIG. 9 illustrates an example of a silhouette template 178, wherein the background of the image is completely white and the content or detail of the collectible item is completely black which thereby defines a silhouette of the outer contour of the collectible item 102. Optionally, the silhouette template 178 may be reformatted from an image file, e.g., JPEG, to a CAD file, e.g., .DXF or SLDPRT.

At step 706, a reference line 180 can be generated and positioned on the initial silhouette template 178. For example, in one embodiment, a user may identify an edge of the collectible item 102 and thereafter generate and position a reference line 180 at the desired edge of the collectible item 102, as illustrated in FIG. 9. In one embodiment, the reference line 180 may be a straight line that corresponds to a straight line of the collectible item 102, along any part of the collectible item. The reference line 180 may set a bottom or base line of the silhouette template 178. At step 708, a bounding frame or box 182 may be generated. The bounding box 182 serves as a reference boundary to subsequently resize the silhouette template 178. In one embodiment, the bounding box 182 can be a rectangular frame, as illustrated in FIG. 10.

At step 710, the initial silhouette template 178 can be located within the bounding box 182. At step 712, the initial silhouette template 178 can be rotated and centered to align the reference line 180 to a corresponding boundary line of the bounding box 182. For example, as shown in the exemplary embodiment of FIG. 10, the silhouette template 178 may be rotated (e.g., approximately 90 degrees) until the reference line 180 thereof was parallel to the vertical side boundary line of the bounding box 182. After correctly aligning the silhouette template 178, the reference line 180 can be removed. Additionally, the silhouette template 178 may be centered within the bounding box 182 such that the outermost edges of the shape of the collectible item 102 may contact the frame walls of the bounding box 182.

At step 714, the collectible item 102 can be measured to determine its true size. For example, an individual may measure a height, width, and/or depth of the collectible item 102 via a measuring tool, such as a ruler or a caliper. At step 716, the boundary box 182 may be resized to match the actual measured size of the collectible item 102. For example, a height of the bounding box 182 can be resized to match the measured height of the actual collectible item 102. Resizing the bounding box 182 to the measured size of the collectible item 102 ensures the accuracy of the silhouette template 178 (and therewith the insert template 200 subsequently generated therefrom). For instance, if the silhouette image is off-center (e.g., if the camera and/or platform were angled, i.e., positioned non-perpendicular, relative to one another) the silhouette image may not display the true dimensions of the collectible item 102. However, after resizing the bounding box 182 to match the size of the collectible item, the silhouette template 178 will accurately display the outer perimeter of the collectible item 102.

At step 718, a path 184 can be traced around the perimeter of the silhouette template 178. The traced path 184 thereby denotes the outer contour of the collectible item 102. Said differently, the traced path 184 may accurately indicate the true size and shape of the collectible item 102. In an example, the traced path 184 can be performed digitally, such as by using Adobe Photoshop. The traced path 184 may be a standalone file or dataset, separate from the file of the silhouette template 178. Optionally, the traced path 184 may be formatted as desired. For example, the traced path 184 may have a stroke width of 0.001 inches. FIG. 11A illustrates an example of a traced path 184.

At step 720, the insert template 200, as shown in FIG. 11B, can be generated by increasing the size of the traced path 184 and overlaying the resized path 184 onto a default insert outline (e.g. a default rectangular box outline with a preset size and shape that corresponds to the uncut sheet 166). For example, in one embodiment, the traced path 184 may be increased by approximately 0.005 inches (increasing the entire perimeter thereof), plus or minus 0.004 inches. The increased traced path size can be included to ensure an easy fit of the custom insert around the die cut collectible item once the custom insert is completed using a laser cutter. Thereafter, the traced path 184 may be aligned vertically and horizontally with the default insert outline. Realigning the traced path 184 ensures that the item opening 122 and the collectible item 102 therein will be properly centered within the insert 106 (and thereby centered within the item section 160 of the item holder). Thereafter, the insert template 200 can be reformatted to a desired file format and sent to the insert production device 144 to subsequently generate the custom insert 106 based upon the insert template 200.

Optionally, the traced path 184 may be altered from an exact trace to an altered approximation at certain points of the silhouette, adding and/or removing space and thereby increasing and/or decreasing a distance between the collectible item 102 and the insert 106 to better protect the collectible item 102. For example, the traced path 184 can be adjusted at certain apexes or corners, corresponding to apexes of the collectible item 102, to provide additional clearance (or less clearance) so that the collectible item 102 does not contact, rub, and/or otherwise move relative to the insert 106.

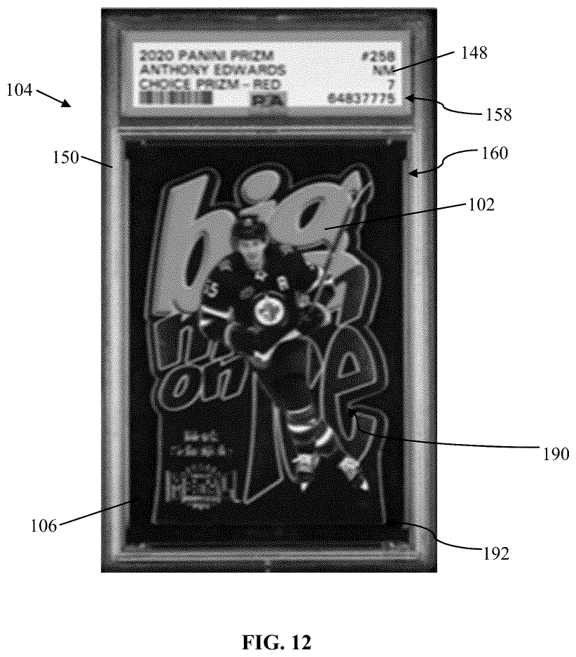

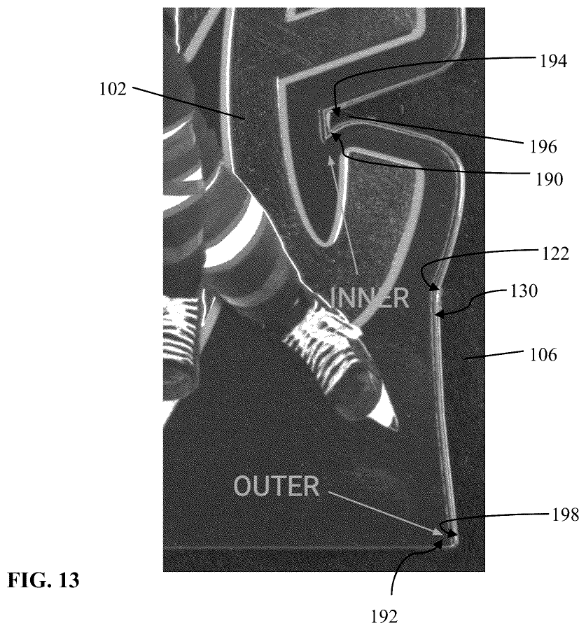

For instance, by way of example only, FIGS. 12-13 illustrate another exemplary embodiment of a collectible item 102, configured as a die cut card 102, that is seated in a corresponding custom insert 106 that was generated using an altered traced path 184. The die cut card of FIGS. 12-13 has inner corners 190 (at the apex 190 of inwardly extending sidewalls) and outer corners 192 (at the apex 192 of outwardly extending sidewalls). To accommodate the corners 190, 192 of the die cut card 102, the traced path 184 may be altered from an exact trace to an altered approximation at the corners 190, 192. For example, the inner corners of the traced path 184 can be rounded (removing any sharp angles to increase a distance between the collectible item 102 and insert 106 at the corner 190) and/or the outer corners can be sharpened (creating a sharp angle or apex in the insert 106 to increase a distance between a corresponding rounded outer corner 192 of the collectible item 102 and the insert 106). Thus, the adjusted rounded and/or sharpened corners of the traced path 184 result in corresponding rounded inner corners 194 on inwardly extending protrusions or arms 196 and/or sharp outer corners 198 of the insert 106 (FIG. 13). Rounding and/or increasing the size of the inside corners of the traced path 184 may also result in a rounder and/or smaller inwardly extending protrusion 196 of the insert 106, allowing the collectible item 102 to more easily fit within the item opening 122 of the insert 106.

To adjust the traced path 184, one or more anchor points thereof may be adjusted and/or an arc of a corner thereof may be adjusted by a preset amount, such as increased by approximately 0.005 inches, plus or minus 0.004 inches. Thereby, the laser cutter 144 may accordingly cut rounded inner corners 194 in the insert 106, corresponding to inner apexes 190 of the collectible item, and sharp outer apexes 198 in the insert 106, corresponding to outer apexes 192 of the collectible item, which prevents the insert 106 from damaging the collectible item 102 when seated therein.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Each memory can have stored thereon instructions that when executed by a hardware processor cause the hardware processor to perform several tasks, including access data files, analyze data files, perform analysis of the data files, and provide outputs indicative of characteristics or parameters represented by the data files. Each hardware processor may comprise any desired processor.

Aspects of the invention cover devices, systems, and methods related to collectible item protection within item holders, including methods of use and manufacture of devices and systems related to collectible item protection.

Although limited embodiments of collectible item holder systems, and methods of operation thereof, have been specifically described and illustrated herein, many modifications and variations will be apparent to those skilled in the art. The method steps disclosed herein can be performed in a differing order as desired. The disclosure is also defined in the following claims.

### EXAMPLE EMBODIMENTS

The following are numbered example embodiments of the apparatuses, devices, systems, and methods related to protecting collectible items within customizable card holders. The below listing of examples or any other examples disclosed herein may be combined in whole or in part. Elements of the examples disclosed herein are not limiting.

Example 1. A method for protecting a collectible item within an item holder. The method includes capturing image data of a collectible item. The method further includes generating an insert template of the collectible item based on the captured image data.

Example 2. The assembly, system, device, apparatus, and method of any of the above Examples alone or in combination, wherein the collectible item comprises a die cut card.

Example 3. The assembly, system, device, apparatus, and method of any of the above Examples alone or in combination, wherein the step of capturing image data comprises capturing a silhouette image of the collectible item.

Example 4. The assembly, system, device, apparatus, and method of any of the above Examples alone or in combination, wherein the insert template is configured to be used by a laser cutter to create a custom insert within which the collectible item is positionable.

Example 5. The assembly, system, device, apparatus, and method of any of the above Examples alone or in combination, wherein the method further comprises generating an initial silhouette template based on the captured image data of the collectible item.

Example 6. The assembly, system, device, apparatus, and method of any of the above Examples alone or in combination, wherein the step of generating the insert template comprises generating a bounding box, positioning the initial silhouette template within the bounding box, and resizing the bounding box, along with the initial silhouette template therein, to match a size of the collectible item.

Example 7. The assembly, system, device, apparatus, and method of any of the above Examples alone or in combination, wherein the step of generating the insert template further comprises tracing a path around the initial silhouette template and increasing a size of the traced path by approximately 0.005 inches to create the insert template.

Example 8. The assembly, system, device, apparatus, and method of any of the above Examples alone or in combination, wherein the step of positioning the initial silhouette template within the bounding box comprises generating and positioning a reference line on the initial silhouette template corresponding to a periphery line of the collectible item and rotating the initial silhouette template to align the reference line thereof to a corresponding boundary line of the bounding box.

Example 9. A method for protecting a collectible item within an item holder. The method comprises capturing image data of a collectible item, generating an insert template of the collectible item based on the captured image data, and forming a custom insert based on the generated insert template. The custom insert is configured to receive and position the collectible item within an item holder.

Example 10. The assembly, system, device, apparatus, and method of any of the above Examples alone or in combination, wherein the custom insert comprises an item opening with a contour that corresponds to a size and a shape of the collectible item.

Example 11. The assembly, system, device, apparatus, and method of any of the above Examples alone or in combination, wherein the custom insert comprises an outer contour that is complimentary to an inner periphery of the item holder.

Example 12. The assembly, system, device, apparatus, and method of any of the above Examples alone or in combination, wherein the outer contour of the custom insert comprises four locating features configured to align and secure the custom insert within the item holder.

Example 13. The assembly, system, device, apparatus, and method of any of the above Examples alone or in combination, wherein the custom insert is a gasket which bounds the collectible item.

Example 14. The assembly, system, device, apparatus, and method of any of the above Examples alone or in combination, wherein the custom insert comprises a clear plastic sheet.

Example 15. The assembly, system, device, apparatus, and method of any of the above Examples alone or in combination, wherein the custom insert comprises a polyethylene terephthalate (PET) sheet.

Example 16. The assembly, system, device, apparatus, and method of any of the above Examples alone or in combination, wherein the step of forming the custom insert comprises laser cutting the custom insert by a laser cutter.

Example 17. The assembly, system, device, apparatus, and method of any of the above Examples alone or in combination, wherein the laser cutter is configured to cut an outer periphery of the custom insert that is complimentary to an inner periphery of the item holder.

Example 18. The assembly, system, device, apparatus, and method of any of the above Examples alone or in combination, wherein the laser cutter is configured to cut an item opening that has a contour that is complimentary to an outer contour of the collectible item.

Example 19. The assembly, system, device, apparatus, and method of any of the above Examples alone or in combination, wherein the method further includes laser cutting, by the laser cutter, rounded inner apexes in the custom insert corresponding to inner apexes of the collectible item.

Example 20. The assembly, system, device, apparatus, and method of any of the above Examples alone or in combination, wherein the method further includes laser cutting, by the laser cutter, sharp outer apexes in the custom insert corresponding to outer apexes of the collectible item, preventing the custom insert from damaging the collectible item when seated therein.

Example 21. A method of producing card holders. The method includes producing a first enclosed card holder. The first enclosed card holder includes a first label, a first collectible item with a first outer contour, and a first insert with a first item opening that receives the first collectible item therein. The first item opening comprises a first interior contour complimentary to the first outer contour of the first collectible item. The method further includes producing a second enclosed card holder. The second enclosed card holder includes a second label, a second collectible item with a second outer contour differing from the first outer contour of the first collectible item, and a second insert with a second item opening that receives the second collectible item therein. The second item opening comprises a second interior contour complimentary to the second outer contour of the second collectible item.

Example 22. The assembly, system, device, apparatus, and method of any of the above Examples alone or in combination, wherein the method further includes laser cutting, by a laser cutter, the first interior contour of the first item opening of the first insert based on image data of the first collectible item.

Example 23. The assembly, system, device, apparatus, and method of any of the above Examples alone or in combination, wherein the method further includes laser cutting, by the laser cutter, the second interior contour of the second item opening of the second insert based on image data of the second collectible item.

Example 24. The assembly, system, device, apparatus, and method of any of the above Examples alone or in combination, wherein the method further includes laser cutting, by a laser cutter, a first outer contour of the first insert complimentary to a first inner periphery of the first enclosed card holder such that the first insert is securely seated within the first enclosed card holder.

Example 25. The assembly, system, device, apparatus, and method of any of the above Examples alone or in combination, wherein the method further includes laser cutting, by the laser cutter, a second outer contour of the second insert complimentary to a second inner periphery of the second enclosed card holder such that the second insert is securely seated within the second enclosed card holder.

Example 26. The assembly, system, device, apparatus, and method of any of the above Examples alone or in combination, wherein the first and second enclosed card holders are produced within three hours of one another.

Example 27. The assembly, system, device, apparatus, and method of any of the above Examples alone or in combination, wherein the first and second enclosed card holders are produced within one hour of one another.

Example 28. A system including an imaging device comprising an optical sensor, a platform, and a light positioned underneath the platform. The optical sensor is configured to capture image data of a collectible item. The system further includes at least one hardware processor in communication with the imaging device and configured to generate an insert template based on the image data. The system further includes an insert production device in communication with the at least one hardware processor and configured to generate an insert based on the insert template. The insert is configured to receive and position the collectible item within an item holder.

Example 29. The assembly, system, device, apparatus, and method of any of the above Examples alone or in combination, wherein the image data includes a silhouette image of the collectible item.

Example 30. The assembly, system, device, apparatus, and method of any of the above Examples alone or in combination, wherein the insert comprises integrated locking features defined by its corners which extend beyond adjacent sidewalls thereof, and the locking features respectively engage with an interior periphery of the item holder to immobilize the insert and the collectible item therein within the item holder.

Example 31. The assembly, system, device, apparatus, and method of any of the above Examples alone or in combination, wherein the insert comprises an item opening that receives the collectible item therein.

Example 32. The assembly, system, device, apparatus, and method of any of the above Examples alone or in combination, wherein the item opening corresponds in shape and size to the collectible item.

Example 33. The assembly, system, device, apparatus, and method of any of the above Examples alone or in combination, wherein the insert comprises an encircled item opening at a center point of its body.

Example 34. The assembly, system, device, apparatus, and method of any of the above Examples alone or in combination, wherein the insert comprises an item opening that is slightly larger than the collectible item.

Example 35. The assembly, system, device, apparatus, and method of any of the above Examples alone or in combination, wherein the insert comprises an item opening that is approximately 0.005 to 0.01 inches greater than an outline of the collectible item.

Example 36. The assembly, system, device, apparatus, and method of any of the above Examples alone or in combination, wherein the insert comprises an item opening that does not cover a front or back of the collectible item.

Example 37. The assembly, system, device, apparatus, and method of any of the above Examples alone or in combination, wherein the insert comprises an item opening that has a depth that is at least equal to or less than a depth of the collectible item.

Example 38. The assembly, system, device, apparatus, and method of any of the above Examples alone or in combination, wherein the insert comprises an item opening configured to receive the collectible item therein, and wherein the insert only engages with a perimeter wall or edge of the collectible item.

Example 39. The assembly, system, device, apparatus, and method of any of the above Examples alone or in combination, wherein the insert is configured to immobilize the collectible item without contacting a front or back surface thereof.

Example 40. The assembly, system, device, apparatus, and method of any of the above Examples alone or in combination, wherein the insert comprises an item opening that includes rounded inner corners and sharp outer corners corresponding to respective corners of the collectible item.

Example 41. The assembly, system, device, apparatus, and method of any of the above Examples alone or in combination, wherein the insert comprises two or more rib cutouts configured to receive corresponding ribs of the item holder therein.

Example 42. The assembly, system, device, apparatus, and method of any of the above Examples alone or in combination, wherein the insert comprises four rib cutouts and diamond-shaped corners.

Example 43. The assembly, system, device, apparatus, and method of any of the above Examples alone or in combination, wherein the insert comprises integrated locking features configured to engage with a body of the item holder to immobilize a body of the insert and therewith the collectible item when seated within the insert.

Example 44. The assembly, system, device, apparatus, and method of any of the above Examples alone or in combination, wherein the insert comprises integrated locking features configured to engage with an inner periphery of the item holder to immobilize the insert when the insert is positioned within the item holder.

Example 45. The assembly, system, device, apparatus, and method of any of the above Examples alone or in combination, wherein each integrated locking feature comprises a polygonal corner of the insert.

Example 46. The assembly, system, device, apparatus, and method of any of the above Examples alone or in combination, wherein each polygonal corner of the insert comprises a rectangular corner extending outward from sidewalls of the insert.

Example 47. The assembly, system, device, apparatus, and method of any of the above Examples alone or in combination, wherein each polygonal corner of the insert is complimentary to and configured to mate with an inner corner of an item section of the item holder, respectively.

What is claimed is:

1. A method of making an insert for use in a cardcase comprising:
capturing image data of a collectible item; and
generating an insert template of the collectible item based on the captured image data.

2. The method of claim 1, wherein capturing image data comprises capturing a silhouette image of the collectible item.

3. The method of claim 1, wherein the insert template is configured to be used by a laser cutter to create a custom insert based on the image data within which the collectible item is positionable.

4. The method of claim 1, wherein the collectible item comprises a die cut card.

5. The method of claim 1, further comprising generating an initial silhouette template based on the captured image data of the collectible item.

6. The method of claim 5, wherein generating the insert template comprises:
generating a bounding box;
positioning the initial silhouette template within the bounding box;
resizing the bounding box, along with the initial silhouette template therein, to match a size of the collectible item;
tracing a path around the initial silhouette template; and
increasing a size of the traced path to define an increased traced path to create the insert template.

7. The method of claim 6, wherein the increasing of the traced path comprises increasing by approximately 0.005 inches.

8. The method of claim 6, wherein positioning the initial silhouette template within the bounding box comprises:
generating and positioning a reference line on the initial silhouette template corresponding to a periphery line of the collectible item; and
rotating the initial silhouette template to align the reference line thereof to a corresponding boundary line of the bounding box.

9. The method of claim 1, further comprising forming a custom insert based on the generated insert template, the custom insert has an outer perimeter and an inner perimeter configured to receive and position the collectible item within the inner perimeter.

10. The method of claim 9, wherein with the inner perimeter has a contour that corresponds to a size and a shape of the collectible item.

11. The method of claim 9, wherein the custom insert comprises a polyethylene terephthalate (PET) sheet.

12. The method of claim 9, wherein forming the custom insert comprises laser cutting the custom insert by a laser cutter.

13. The method of claim 12, further comprising:
laser cutting, by the laser cutter, rounded inner apexes in the custom insert corresponding to inner apexes of the collectible item; and
laser cutting, by the laser cutter, sharp outer apexes in the custom insert corresponding to outer apexes of the collectible item, preventing the custom insert from damaging the collectible item when seated therein.

14. A system comprising:
an imaging device comprising an optical sensor, a platform, and a light positioned underneath the platform, the optical sensor configured to capture image data of a collectible item, the image data including a silhouette image of the collectible item;
at least one hardware processor in communication with the imaging device and configured to generate an insert template based on the image data; and
an insert production device in communication with the at least one hardware processor and configured to generate an insert based on the insert template, the insert configured to receive and position the collectible item within an item holder.

15. The system of claim 14, wherein the insert comprises integrated locking features configured to engage with an inner periphery of the item holder to immobilize the insert when the insert is positioned within the item holder.

16. A combination cardcase and collectible item comprising:
a first housing piece attached to a second housing piece, the first housing piece and the second housing piece having a upper wall, a lower wall, and a sidewall that collectively define an interior space;
a label section and an item section formed in the interior space by one or more ribs;
the collectible item having a body with an outer contour positioned in the item section of the interior space;
a label having a body with identifier information about the collectible item located in the label section of the interior space;
an insert, having an outer perimeter and an item opening having an inner perimeter located inwardly of the outer perimeter, positioned in the item section of the interior space and the collectible item is located at least in part in the item opening of the insert; and
wherein the outer contour of the collectible item has a shape that is other than square or rectangular.

17. The combination of claim 16, wherein the outer contour of the collectible item has a complex curve with at least four inflection points.

18. The combination of claim 17, wherein the inner perimeter of the insert has a contour that is complementary with the outer contour of the collectible item.

19. The combination of claim 18, wherein the insert has four straight edges with each straight edge being generally right angle to two adjacent straight edges.

20. The combination of claim 19, wherein the insert has four corners and wherein each of the four corners has a corner tab that extends outwardly of an outer perimeter defined by the four straight edges.
